(19) United States
(12) Patent Application Publication
(10) Pub. No.: US 2024/0360859 A1
(43) Pub. Date: Oct. 31, 2024

(54) CONNECTING INFLATABLE COMPONENTS AND RELATED METHODS

(71) Applicant: Phoenix International Holdings, Inc., Largo, MD (US)

(72) Inventors: Robert L. Lohe, Annapolis, MD (US); Spencer Hudson, Woodbridge, VA (US); Mitchell R. Loyd, Prince Frederick, MD (US)

(73) Assignee: Phoenix International Holdings, Inc., Largo, MD (US)

(21) Appl. No.: 18/628,701

(22) Filed: Apr. 6, 2024

Related U.S. Application Data
(60) Provisional application No. 63/461,984, filed on Apr. 26, 2023.

(51) Int. Cl. F16B 7/04

(52) U.S. Cl. CPC F16B 7/0493

(57) ABSTRACT

Inflatable apparatuses that may be used in underwater environments to support telecommunications conductors and/or associated sensors are configured and constructed using multiple components connected using innovative joints and related methods.

### RELATED APPLICATION

This application claims priority to U.S. Provisional Application No. 63/461,984 filed Apr. 26, 2023 (the “'984 application). This application incorporates by reference the entire disclosure of the '984 application as if it were set forth in full herein.

### US GOVERNMENT LICENSE RIGHTS

The inventive disclosures herein were made with U.S. government support under Contract Number N68335-22-C-0433 awarded by the United States Navy. The U.S. government has certain rights in the inventive disclosures.

### INTRODUCTION

This section introduces aspects that may help facilitate a better understanding of the disclosure. Accordingly, the statements of this section are to be read in this light and are not to be understood as admissions about what is, or what is not, prior art.

It is desirable to provide methods for connecting inflatable apparatuses that may support communications conductors and associated sensors underwater.

### SUMMARY

The inventors describe various exemplary methods of constructing, configuring and connecting inflatable apparatuses that may be used in underwater environments.

In one embodiment, an inventive method comprises connecting inflatable components by forming a joint between the components, where the joint has sufficient rotational stiffness and stability yet is still flexible enough to allow for movement of the joint without breaking the connection between components.

In an embodiment, the perpendicular distance from the bottom of a base of each respective component to a respective seal edge of a respective component (described herein) should be kept to a minimum to ensure the joint maintains a sufficient degree of rotational stiffness and rigidity as the joint rotates.

Another method for connecting inflatable components may comprise: folding a first inflatable portion comprising a first edge flap surface of a first heat sealable component (“first component”) on top of a second inflatable portion comprising a second edge flap surface of the first component; applying heat along substantially an entire edge formed by the folded first and second inflatable portions of the first component to form a respective heat-sealed edge connection of the first component; folding a first inflatable portion comprising a first edge flap surface of a second heat sealable component (“second component”) on top of a second inflatable portion comprising a second edge flap surface of the second component; applying heat along substantially an entire edge formed by the folded first and second inflatable portions of the second component to form a respective heat-sealed edge connection of the second component; configuring the first and second edge flap surfaces of the first component as a first base; configuring the first and second edge flap surfaces of the second component as a second base; and connecting the first and second bases by applying a force to one or more of the bases, wherein the connection has a polar second moment of area about an axis that is perpendicular to centers of the first and second bases.

In such a method the first and second bases may comprise an amorphous sealant layer, where the method may further comprise applying heat to the respective amorphous sealant layers of each respective base to form a joint, and wherein a first perpendicular distance from a bottom of the first base to a respective heated-sealed edge connection of the first component may be kept to a minimum and a second perpendicular distance from a bottom of the second base to a respective heated-sealed edge connection of the second component may also be kept to a minimum to ensure the joint maintains a sufficient degree of rotational stiffness and rigidity as the joint rotates.

Still another method for connecting inflatable components may comprise: folding a first inflatable portion comprising a first edge flap surface of a first adhesive sealable component (“first component”) on top of a second inflatable portion comprising a second edge flap surface of the first component, where the first inflatable portion comprises an external surface of the first component; applying a force along substantially an entire edge formed by the folded first and second inflatable portions of the first component to form an adhesive-sealed edge connection of the first component; folding a first inflatable portion comprising a first edge flap surface of a second adhesive sealable component (“second component”) on top of a second inflatable portion comprising a second edge flap surface of the second component, where the first inflatable portion comprises an external surface of the second component; applying a force along substantially an entire edge formed by the folded first and second inflatable portions of the second component to form an adhesive-sealed edge connection of the second component; configuring the first and second edge flap surfaces of the first component as a first base; configuring the first and second edge flap surfaces of the second component as a second base; and connecting the first and second bases by applying a force to one or more of the bases, wherein the connection has a polar second moment of area about an axis that is perpendicular to centers of the first and second bases.

In such a method one or more of the first and second bases may comprise an adhesive layer, and the method may alternatively comprise applying heat to the respective adhesive layer or layers to form a joint.

Further, a first perpendicular distance from a bottom of the first base to a respective adhesive-sealed edge connection of the first component may be kept to a minimum and a second perpendicular distance from a bottom of the second base to a respective adhesive-sealed edge connection of the second component may also be kept to a minimum to ensure the joint maintains a sufficient degree of rotational stiffness and rigidity as the joint rotates.

In addition to methods the present disclosure also provides inventive apparatuses. One such apparatus for supporting a communications conductor may be formed by connecting inflatable components at a joint between the components, where such an apparatus may comprise: a first inflatable beam and a second inflatable beam connected by a cross-component joint, wherein the joint comprises an internal, open passageway to allow a medium to pass through the passageway from one of the first or second beams to the other second or first beams, where the cross-component joint is configured to allow movement of the joint without breaking the joint. In such an apparatus the medium may comprise water, the communications conductor may comprise an optical fiber and the first and second inflatable beams may comprise a heat-sealable material (e.g., a 48, 80, or 128 gauge Mylar® 850 AB coex sealant film).

Still further, in such an apparatus each of the first and second inflatable beams may comprise a PET crystalline layer on a first surface and an amorphous sealant layer on a second surface.

Yet further, in such an apparatus each of the first and second beams may comprise one or more surfaces coated with an adhesive.

The joint in such an apparatus may have a polar second moment of area about an axis that is perpendicular to centers of bases of the first and second beams, where a perpendicular distance from a bottom of a base of each respective beam to a respective seal edge of each respective beam may be kept to a minimum to ensure the joint maintains a sufficient degree of rotational stiffness and rigidity as the joint rotates.

Another inventive apparatus that may be formed by connecting inflatable components may comprise: one or more curved inflatable components and one or more straight inflatable components, wherein each of the one or more curved inflatable components is connected to at least one of the one or more straight inflatable components at a cross-component joint thereby forming a plurality of cross-component joints, wherein each of the plurality of cross-component joints comprises an internal, open passageway to allow a medium to pass through the passageway from a respective curved inflatable component to a respective straight inflatable component or vice-versa, where each of the cross-component joints are configured to allow movement of a respective joint without breaking the respective joint.

In such an apparatus the one or more curved inflatable components and the one or more straight inflatable components may form a helically shaped apparatus.

In such an apparatus the one or more curved inflatable components and the one or more straight inflatable components may form a shaped apparatus selected from a circular, conical, general, cylindrical or slanted helically-shaped apparatus.

Further, one or more of the cross-component joints may be located at an inner diameter of the apparatus, or alternatively, the one or more cross-component joints may be located at an outer diameter of the apparatus.

The inventive methods and corresponding apparatuses described herein are just some of the inventive apparatuses and methods that will be apparent from the discussion herein.

### BRIEF DESCRIPTION OF THE DRAWINGS

The present disclosure is illustrated by way of example and is not limited by the accompanying figures. In the figures, similar reference numbers may denote similar components and/or features throughout the attached drawings in which:

FIG. 1 depicts a simplified illustration of exemplary components that may be used in an underwater environment according to one embodiment of the present disclosure.

FIG. 2 depicts a simplified illustration of components of an inventive apparatus at an early stage of construction according to one embodiment of the present disclosure.

FIG. 3 illustrates a state of inventive components according to an embodiment of the present disclosure.

FIG. 4 depicts an additional state of inventive components according to an embodiment of the present disclosure.

FIGS. 5A to 5C depict different views of a configuration of inventive components connected according to an embodiment of the present disclosure.

FIG. 5D depicts a simplified illustration of part of a passageway in an inventive component according to an embodiment of the present disclosure.

FIG. 6 depicts an exemplary apparatus comprising inventive components that may be used in underwater environment according to an embodiment of the present disclosure.

FIG. 7 depicts curved-shaped components making up a curved component according to an embodiment of the disclosure.

FIG. 8 depicts another view of the curved-shaped components making up the curved component in FIG. 7 according to an embodiment of the disclosure.

FIG. 9 depicts yet another view of the exemplary components making up an exemplary component in FIG. 7 according to an embodiment of the disclosure.

FIGS. 10 to 12 depict an exemplary curved component and a second, non-curved component according to an embodiment of the disclosure.

FIG. 13 depicts an exemplary component that includes portions for supporting a communications conductor according to an embodiment of the disclosure.

FIG. 14 depicts a portion of an exemplary apparatus according to an embodiment of the disclosure.

FIG. 15 depicts an exemplary apparatus, a portion of which is shown in FIG. 14, according to an embodiment of the disclosure.

FIG. 16 depicts an alternative, exemplary apparatus according to an embodiment of the disclosure.

Specific embodiments of the present disclosure are set forth herein with reference to various figures and sketches. Both the description and the illustrations have been drafted with the intent to enhance understanding. For example, the dimensions of some of the elements in the figures may be exaggerated relative to other elements, and well-known elements that are beneficial or even necessary to a commercially successful implementation may not be depicted so that a less obstructed and a clearer presentation of embodiments may be achieved.

Simplicity and clarity in both illustration and description are sought to effectively enable a person of skill in the art to make, use, and best practice the embodiments of the present disclosure in view of what is already known in the art. One skilled in the art will appreciate that various modifications and changes may be made to the specific embodiments described below without departing from the spirit and scope of the present disclosure. Thus, the specification and drawings are to be regarded as illustrative and exemplary rather than restrictive or all-encompassing, and all such modifications to the specific embodiments described below are intended to be included within the scope of the present disclosure.

### DETAILED DESCRIPTION, WITH EXAMPLES

Embodiments of inflatable apparatuses, such as those that include cross-component joints, and related methods are described herein and are shown by way of example in the drawings. The detailed description that follows describes embodiments and is not intended to be limited to the expressly disclosed combination(s). Therefore, unless otherwise noted, features disclosed herein may be combined to form additional combinations that were not otherwise shown for purposes of brevity. Numerous other embodiments, modifications and variations within the scope and spirit of the appended claims will occur to persons of ordinary skill in the art from a review of this disclosure.

As used herein and in the appended claims, the term “comprises,” “comprising,” or variations thereof are intended to refer to a non-exclusive inclusion, such that a process, method, article of manufacture, or apparatus (e.g., a generator) that comprises a list of elements does not include only those elements in the list, but may include other elements not expressly listed or inherent to such process, method, article of manufacture, or apparatus.

The terms “a” or “an”, as used herein, are defined as one, or more than one. The term “plurality”, as used herein, is defined as two, or more than two. The term “another”, as used herein, is defined as at least a second or more.

Unless otherwise indicated herein, the use of relational terms, if any, such as “first” and “second”, “top” and “bottom”, and the like are used solely to distinguish one view, entity, or action from another view, entity, or action without necessarily requiring or implying any actual such relationship, order, or importance between such views, entities, or actions.

The terms “including” and/or “having”, as used herein, are defined as comprising (i.e., open language).

As used herein “x-axis” or “first axis”, “y-axis” or “second axis” and “z-axis” or “third axis” mean three different geometric directions and planes. Typically, the x-axis is used to indicate motion in a horizontal direction/plane, the y-axis is used to indicate motion in the vertical direction/plane and the z-axis is used to indicate motion in an axis that is perpendicular to both the x and y axes. However, depending on the orientation and supporting structure of an apparatus the origin or orientation of the three axes may be interchangeable.

To the extent any shape, dimension, weight, size, percentages or operating parameters (collectively “parameters”), are described herein or shown in the figures it should be understood that such parameters are non-limiting and merely exemplary to allow those skilled in the art to understand the inventive embodiments described herein. Further, to the extent that any of the figures or text included herein depict or describe parameters, it should be understood that such information is merely exemplary and non-limiting and is provided to enable one skilled in the art to practice an exemplary embodiment of the disclosure.

It should also be understood that one or more exemplary embodiments may be described as a process or method. Although the steps in a process/method may be described or depicted as sequential, it should be understood that such steps in a process/method may also be performed in parallel, concurrently or simultaneously. In addition, the order of each step within a process/method may be re-arranged. A process/method may be terminated when completed or may include additional steps not included in the description or depiction of the process/method.

It should be understood that when one part or step in an innovative apparatus or method is described or depicted as being “connected” to another part or step, other parts or steps used to facilitate such a connection may not be described or depicted because such parts or steps are well known to those skilled in the art.

Yet further, when one part or step of an apparatus or method is described or depicted as being connected to another part or step in a figure it should be understood that, practically speaking, such a connection may comprise (and many times will comprise) more than one physical connection or processing step.

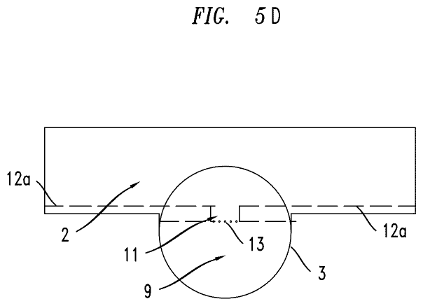

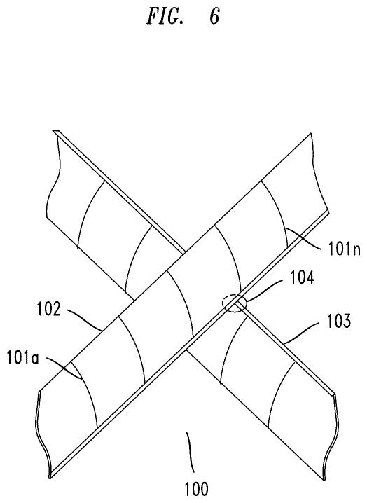

It should be noted that the apparatuses, as well as any components or elements thereof, illustrated in the figures are not necessarily drawn to scale and need not be representative of an actual shape or size and need not be representative of any actual apparatus. Rather, the apparatuses, components and elements are drawn to help explain the features, functions, and processes of various exemplary embodiments of the described disclosure.

Where used herein, the letter “a” used with a numeral may denote the first step or component of one or more steps or components and the letter “n” used with a numeral may denote the last step or component of one or more steps or components (e.g., indicators 101a to 101n in FIG. 6).

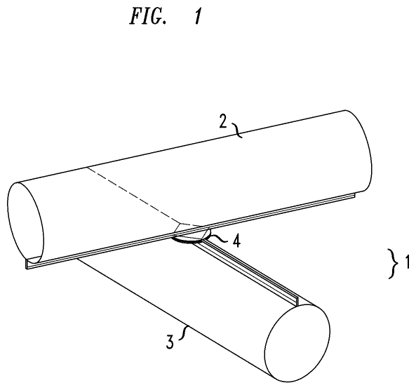

Referring to FIG. 1, there is depicted a simplified illustration of an exemplary apparatus 1 that may be used in underwater environments according to one embodiment of the present disclosure.

Exemplary apparatus 1 may include at least two inflatable components (sometimes referred to as right-circular inflatable “beams” or “first” and “second” inflatable beams) 2,3 connected by joint 4 (e.g., a cross-component joint) to support a communications conductor (not shown but see conductor 27 in FIG. 13) and associated sensors. Thus, it can be said that one exemplary embodiment of apparatus 1 may comprise a first inflatable beam 2 and a second inflatable beam 3 connected by a cross-component joint 4.

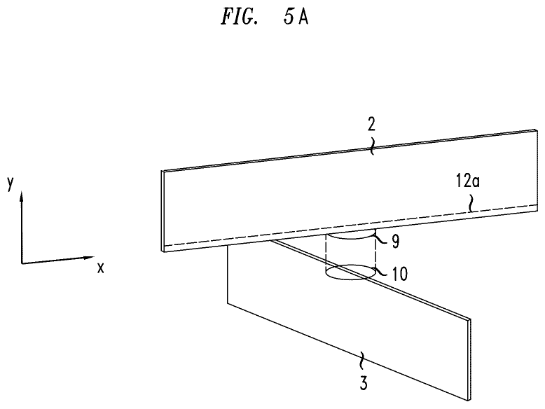

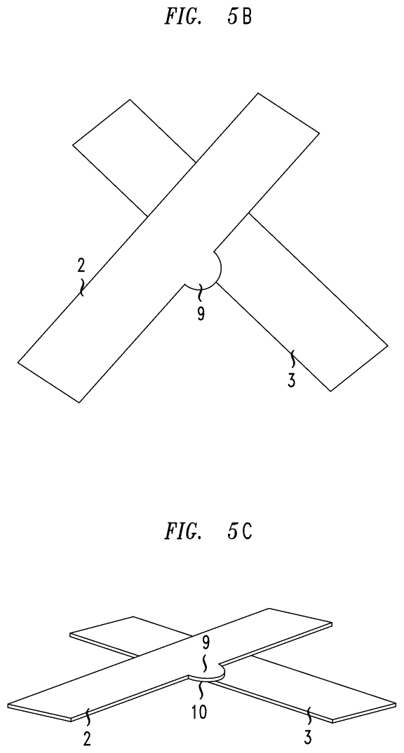

Joint 4 may comprise an internal, open passageway that allows a medium, such as water to pass through the passageway from one inflatable beam t 2,3 into another inflatable beam 2,3 (see passageway 11 in FIG. 5D; either from beam 2 to beam 3, or from beam 3 to beam 2). Herein, the word “beam” may be used interchangeable with the word “component”.

In one embodiment, the cross-component joint 4 may be configured (and composed) to allow movement of the joint 4 without breaking the joint 4 joint because apparatus as in claim 7 wherein formed by connecting inflatable components at a joint between the components, where a perpendicular distance from at the bottom of a base of each respective beam component to a respective seal edge of each a respective beam component is kept to a minimum to ensure the joint maintains a sufficient degree of rotational stiffness and rigidity as the joint rotates. Said another way the joint 4 may be configured (as explained in more detail herein) to have a polar second moment of area about an axis that is perpendicular to centers of bases of the first and second beams.

In an embodiment, the communications conductor may comprise an optical fiber to name just one type of communications conductor that may be utilized.

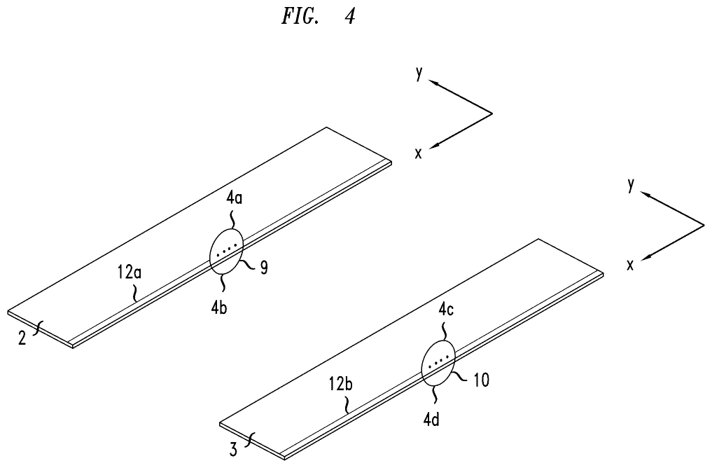

Though only two inflatable components 2,3 and one joint 4 are depicted in the figures herein it should be understood that additional exemplary apparatuses may include more than two inflatable components and more than one joint configured and constructed using similar steps and materials as described herein (e.g., a multitude of components and joints connected together to form a stack when inflated measuring 18 or 19 feet in total height, it being understood that these dimensions are merely exemplary and that other dimensions can be used to form one or more geometries within the bounds of component bending calculations). Though each inflatable component 2,3 is depicted as a flat sheet it should be understood that each component 2,3 has a thickness that together with its other dimensions may enclose a volume of liquid (or a gas, such as air) when inflated. In one embodiment, each component 2,3 may measure 50 to 60 inches in length along its x-axis (see FIG. 4), it again being understood that these dimensions are merely exemplary and that other dimensions can be used.

As described in more detail below each of the first and second inflatable beams may comprise a heat-sealable material and/or an adhesive layer.

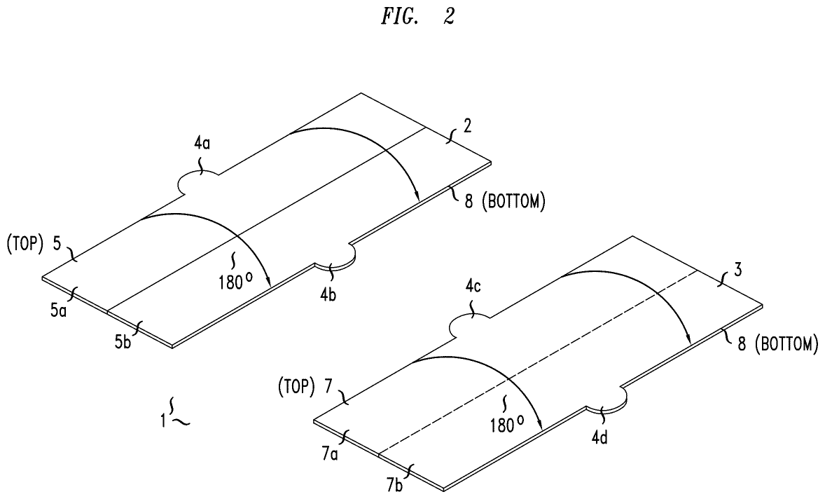

FIGS. 2 through 5C depict apparatus 1 at various states or stages of construction.

As shown in FIGS. 2 to 5C and as will be explained in more detail herein, one exemplary method of forming the apparatus 1 that comprises connected, inflatable components may comprise the following steps: folding a first inflatable portion 5a comprising a first edge flap surface 4a of a first heat sealable component (“first component”) 2 on top of a second inflatable portion 5b comprising a second edge flap surface 4b of the first component 2; applying heat along substantially an entire edge formed by the folded first and second inflatable portions 5a, 5b of the first component 2 to form a respective heat-sealed edge connection of the first component 2; folding a first inflatable portion 7a comprising a first edge flap surface 4c of a second heat sealable component (“second component”) 3 on top of a second inflatable portion 7b comprising a second edge flap surface 4d of the second component 3; applying heat along substantially an entire edge formed by the folded first and second inflatable portions 7a, 7b of the second component 3 to form a respective heat-sealed edge connection of the second component; configuring the first and second edge flap surfaces 4a, 4b of the first component as a first base 9; configuring the first and second edge flap surfaces 4c, 4d of the second component as a second base 10; and connecting the first and second bases 9, 10 by applying a force to one or more of the bases, wherein the connection has a polar second moment of area about an axis that is perpendicular to centers of the first and second bases 9,10.

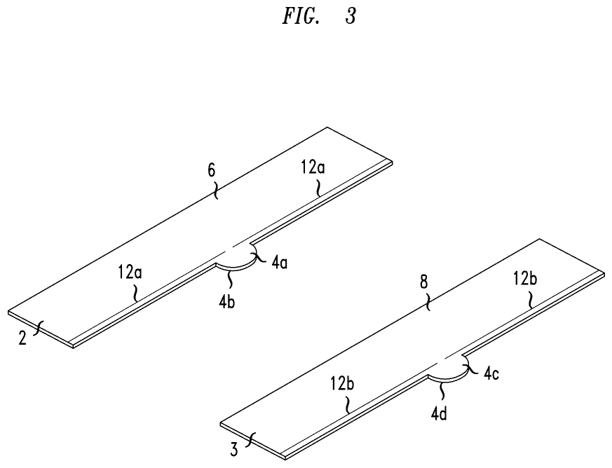

In slightly more detail, referring now to FIG. 2 there is depicted a simplified illustration of the two components 2,3 (sometimes referred to as “first” second” components) at an early stage of construction (i.e., before they are connected). As shown, each component 2,3 may be configured as a substantially flat, rectangular-shaped component and include one or more connectable edge flap surfaces 4a,4b (sometimes referred to as “first” and “second” edge flap surfaces of the first component 2) and 4c, 4d ((sometimes referred to as “first” and “second” edge flap surfaces of the second component 3). Though shown as rectangular-shaped, it should be understood that this is merely exemplary. Alternatively, the components 2,3 may be curved (see, for example, FIGS. 7 to 10). In one embodiment, one surface 5,7 of each component 2,3 (i.e., a top surface) may be folded by moving (i.e., folding) a portion 5a, 7a such that one portion 5a,7a now rests on top of another portion 5b, 7b (see FIG. 3). In more detail, a first portion 5a of component 2 may be placed over a second portion 5b of component 2 by folding the surface 5 such that the portion 5a now rests on top of portion 5b. Similarly, a first portion 7a of component 3 may be moved on top of a second portion 7b of component 3 by folding the portion 7a such that the portion 7a now rests on top of portion 7b.

FIG. 3 illustrates the state of apparatus 1 after components have been so folded. After each component has been folded, the opposite surfaces 6,8 of each component 2,3 are external surfaces (i.e., the bottom surfaces 6,8 are external surfaces). When the respective components 2,3 are configured as shown the respective edge flap surfaces 4a,4b of component 2 and edge flap surfaces 4c,4d of component 3 also are configured to rest aside one another.

In one embodiment, each component 2,3 may be composed of a heat-sealable material such as a 48, 80, or 128 gauge Mylar® 850 AB coex sealant film having a PET crystalline layer on surfaces 6,8 (“first” surfaces”) and an amorphous sealant layer on surfaces 5a,5b and 7a, 7b (“second surfaces”) though it should be understood that the specific type of heat-sealable material may depend upon the specific application. After components 2,3 have been folded as described above heat may be applied along substantially the entire edges of each so folded component 2,3 (indicated by seal edges 12a, 12b in FIG. 3) to create a heat-sealed connection.

Alternatively, rather than be composed of a heat-sealable material (or in addition to being composed of a heat-sealable material), one or more of the surfaces of components 2,3 (e.g., an edge of portion 5a and/or 5b or an edge of portion 7a and/or 7b) may be coated with an adhesive layer such that when one portion is folded on top of another portion the respective edges of portions 5a, 5b and 7a,7b may be adhesively connected together along substantially the entire edges of each component 2,3 (see seal edges 12a, 12b in FIG. 3). If desired heat may be applied to the edges to create a heat-sealed connection along substantially the entire edges of each component 2,3 (again, seal edges 12a, 12b in FIG. 3).

As will be explained in more detail herein, an exemplary method for forming such an apparatus that uses an adhesive to connect inflatable components may comprise the following steps: folding a first inflatable portion 5a comprising a first edge flap surface 4a of a first adhesive sealable component (“first component”) 2 on top of a second inflatable portion 5b comprising a second edge flap surface 4b of the first component 2; applying a force along substantially an entire edge formed by the folded first and second inflatable portions 5a, 5b of the first component 2 to form an adhesive-sealed edge connection 12a of the first component; folding a first inflatable portion 7a comprising a first edge flap surface 4c of a second adhesive sealable component (“second component”) 3 on top of a second inflatable portion 7b comprising a second edge flap surface 4d of the second component 3; applying a force along substantially an entire edge formed by the folded first and second inflatable portions 7a, 7b of the second component 3 to form an adhesive-sealed edge connection 12b of the second component 3; configuring the first and second edge flap surfaces 4a, 4b of the first component 2 as a first base 9; configuring the first and second edge flap surfaces 4c, 4d of the second component 3 as a second base 10; and connecting the first and second bases 9, 10 by applying a force to one or more of the bases, wherein the connection has a polar second moment of area about an axis that is perpendicular to centers of the first and second bases 9,10.

It should be noted that depending on the composition of the adhesive and/or the composition of the material making up the components 2,3, an adhesive layer may be applied to each opposing (and facing) edges of portions 5a,5b and 7a,7b. For example, if the adhesive coated layer is composed of a contact cement type of coating or similar, then each opposing edge of a portion of a component may be coated with a layer of adhesive (e.g., edges of both 5a and 5b; edges of both 7a and 7b). In contrast, if the composition of the adhesive coated layer is a super glue or similar then only one opposing edge of a portion of a component may be coated with a layer of adhesive (e.g., either 5a or 5b; either 7a or 7b). Similarly, the material composition of each component may determine the type of adhesive to be used and whether one or both opposing edges may be coated with a layer of adhesive based on the physical or chemical interaction of the material composition with the adhesive.

In embodiments, the edge flap surfaces 4a,4b and 4c,4d may not be connected at this point in the construction of the apparatus 1. Though not connected, the respective edge flap surfaces 4a,4b and 4c,4d may be in contact with one another.

In slightly more detail, and with reference now to FIG. 4, there is shown an exemplary state of apparatus 1. As shown the edge flap surfaces 4a,4b of surface 5 of component 2 (edge flap surface 4a is a part of portion 5a and edge flap surface 4b is a part of portion 5b) and edge flap surfaces 4c,4d of surface 7 of component 3 (edge flap surface 4c is a part of portion 7a and edge flap surface 4d is a part of portion 7b) may be configured to form respective, connecting bases 9, 10. For example, each flap surface 4a,4b and 4c, 4d may be moved from an initial position in FIG. 3 to the position shown in FIG. 4 (e.g., moved through an angle of approximately 90 degrees). In more detail, each of edge flap surfaces 4a,4b may be moved in opposite directions from their initial positions in FIG. 3 to the positions shown in FIG. 4, while each of edge flap surfaces 4c,4d may similarly be moved in opposite directions from their initial positions in FIG. 3 to the positions shown in FIG. 4 (e.g., moved through an angle of approximately 90 degrees) . . . . After the respective edge flap surfaces 4a,4b and 4c,4d have been so configured the combination of a set of edge flap surfaces 4a,4b and 4c,4d may form respective bases 9,10.

As noted previously, in one embodiment the respective bases 9, 10 (and their respective edge flap surfaces) may be composed of a heat sealable material having a similar composition as described previously. In an embodiment, after bases 9, 10 have been configured and positioned as shown in FIG. 4, a joint 4 may be formed by forcing the bases 9, 10 together and applying heat. Said another way, when the first and second bases 9, 10 comprise an amorphous sealant layer, a joint may be formed by applying heat to the respective amorphous sealant layers of each respective base 9, 10.

In more detail, an amorphous sealant layer or similar layer on the surface of one opposing base 9 (i.e., its respective edge flap surfaces 4a,4b) and an amorphous sealant layer or similar layer on the surface of opposing base 10 (i.e., its respective edge flap surfaces 4c,4d) may be aligned and forced together such that when heat is applied a heat-sealed connection is created forming joint 4. In an alternative embodiment, an amorphous sealant layer or similar layer on the surface of one opposing base 10 (i.e., its respective edge flap surfaces 4c,4d) and an amorphous sealant layer or similar layer on the surface of opposing base 9 (i.e., its respective edge flap surfaces 4a, 4b) may be aligned and forced together such that when heat is applied a heat-sealed connection is created forming joint 4.

Similar to above, instead of (or in addition to) being composed of a heat-sealable material, bases 9, 10 may be coated with an adhesive layer.

In more detail, the edge flap surfaces 4a,4b of base 9 that face base 10 and/or the edge flap surfaces 4c, 4d of base 10 that face base 9 may be coated with an adhesive layer such that when the respective bases 9 and 10 are forced together the force and adhesive create a bond between the respective bases 9,10 to connect respective components 2,3 adhesively together. If desired, heat may be applied to the bases 9, 10 to create a heat-sealed connection between respective bases 9, 10.

It should be noted that depending on the composition of the adhesive and/or the composition of the material making up the bases 9, 10, an adhesive layer may be applied (or coated) to only one or both opposing and facing edge flap surfaces of bases 9, 10. Said another way, an adhesive layer may be applied (or coated) to both edge flap surfaces 4a,4b and 4c,4d or an adhesive layer may be applied (or coated) to only one of the opposing and facing edge flap surfaces 4a,4b or 4c,4d.

For example, if the adhesive coated layer is a contact cement type of coating or similar, then each opposing edge flap surface 4a,4b and 4c,4d of each base 9, 10 may be coated with an adhesive layer. In contrast, if the type of adhesive coated layer is a super glue or similar then only one opposing set of edge flap surfaces 4a,4b or 4c,4d of one base 9, 10 may be coated with an adhesive layer. Similarly, the material composition of each base 9, 10 may determine the type of adhesive to be used and whether one or both sets of opposing and facing edge flap surfaces of a base may be coated with a layer of adhesive based on the physical or chemical interaction of the material composition with the adhesive.

The inventors believe that the formation of a joint 4 comprising bases 9, 10 connecting components 2,3 results in a joint 4 that has increased rotational stiffness and stability, yet the joint 4 is still flexible enough to allow for movement of the joint 4 without breaking the connection (i.e., the joint) as compared with joints that are not comprised of bases 9, 10 because the geometric planes containing bases 9,10 are in shear for any rotation of the components 2,3 relative to each other about an axis perpendicular to the center of the bases 9,10. Said another way, as configured, bases 9,10 can be said to have a sufficiently high polar second moment of area about an axis that is perpendicular to the center of bases 9,10, and, therefore, can withstand greater torsion with less rotational deflection.

In an embodiment, the perpendicular distance from the bottom of a base 9,10 to its respective seal edge 12a, 12b (heat-sealed edge connection or adhesive-sealed edge connection) should be kept to a minimum to ensure the joint 4 maintains a degree of rotational stiffness and rigidity. Said another way, in forming the joint an exemplary method should ensure that a first perpendicular distance from a bottom of the first base 9 to a respective heated-sealed or adhesive edge connection of the first component 2 is kept to a minimum and a second perpendicular distance from a bottom of the second base 10 to a respective heated-sealed or adhesive-sealed edge connection of the second component 3 is kept to a minimum to ensure the joint 4 maintains a sufficient degree of rotational stiffness and rigidity as the joint rotates.

Referring now to FIGS. 5A to 5C, there is depicted different views of the configuration of apparatus 1 prior to inflation by air or a liquid (e.g., water). FIGS. 5A and 5C depict side views of the base-to-base connection of component 2 and its base 9 as it is being connected to component 3 and its base 10 while FIG. 5B depicts a top view of the base-to-base connection of component 2 and its base 9 to component 3 and its base 10.

In embodiments of the disclosure each component 2,3 may be connected such that, at the joint 4, a geometric plane containing one component is approximately orthogonal to at least one other geometric plane containing another component. For example, In FIG. 5A the geometric plane containing component 2 is approximately orthogonal to the geometric plane containing component 3 as the two components 2,3 are connected.

In yet a further embodiment the angle between the two planes containing component 2 and component 3 at the joint 4 may be in the range of 85 to 95 degrees, or 87 degrees or 93 degrees, for example.

Once connected the bases 9, 10 form the joint 4 as shown in FIG. 1.

Referring now to FIG. 5D there is depicted a simplified illustration of part of passageway 11 that may be formed within joint 4 when the two bases 9, 10 of apparatus 1 are connected. In FIG. 5D only one half of the passageway 11 formed within the base 9 of component 2 is shown, it being understood that a similar passageway is formed in base 10 of component 3. In an embodiment, when the two bases are connected the two passageways form one passageway between components 2,3 that allows a fluid (e.g., seawater), air or another inflatable medium to pass through the passageway from one component 2,3 into another component 2,3 in order to inflate the apparatus 1. In one embodiment the diameter of the passageway formed when bases 9,10 are connected may measure 0.25-0.5 inches and may have a length of 0.125 inches to provide just one exemplary set of dimensions, it being understood that the length should be minimized to make the joint stiffer as the joint rotates.

In FIG. 5D the dashed lines associated with numeral 12a indicate the approximate positions where a heat-sealed connection (i.e., a seal edge) may be created and/or where an adhesive may be applied to component 2 while the dashed lines associated with numeral 13 indicate the approximate positions where the component 2 was folded as previously described.

Referring now to FIG. 6 there is depicted an exemplary, inflated apparatus 100 for supporting a communications conductor and associated sensors that may be used in underwater environment and may be similarly configured and constructed as described herein. Apparatus 100 includes at least inflatable component 102 (“first inflatable component”) and inflatable component 103 (“second inflatable component”) connected by joint 104. In this embodiment, inflatable components 102,103 may be composed of a polyethylene film material. Apparatus 100 may also include one or more indicators 101a to 101n for visually identifying the components 102, 103 (i.e., underwater, components may be hard to see, so indicators, e.g., stripes, may be added to allow the components to be located, identified and/or viewed).

As noted previously, components making up an exemplary apparatus need not be rectangular-shaped. For example, with reference to FIG. 7, there are depicted two curved-shaped components 15,16 making up curved component 14.

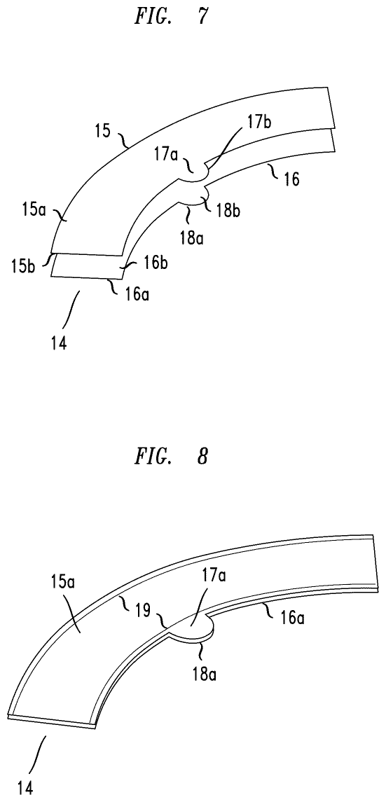

In FIG. 8, the state of the curved inflatable component 14 is depicted after the interior surfaces 15b, 16b of each component 15,16 have been moved to rest aside each other. In an embodiment, the inflatable components 15,16 may be composed of a heat-sealable material (e.g., 48, 80 or 128 gauge Mylar® 850 AB coex sealant film having a PET crystalline layer (“first” or exterior surfaces 15a, 16a) and an amorphous sealant layer (“second” or interior surfaces 15b, 16b) though it should be understood that the specific type of heat-sealable material may depend upon the specific application). In FIG. 8, heat may be applied to inflatable components 15,16 along substantially the entire edges of each inflatable component 15,16 (indicated by seal edge 19 in FIG. 8) to create a heat-sealed connection. When the respective inflatable components 15,16 are configured as shown, opposing edge flap surfaces 17b,18b are also configured to rest aside one another.

In more detail, an amorphous sealant layer or similar layer 15b and an amorphous sealant layer or similar layer 16b may be aligned and forced together such that when heat is applied a heat-sealed connection is formed. In an alternative embodiment, the sealant layer 16b and the sealant layer 15b may be aligned and forced together such that when heat is applied a heat-sealed connection is formed.

Alternatively, rather than be composed of a heat-sealable material (or in addition to being composed of a heat-sealable material) one or more of the edges of surfaces 15b, 16b (e.g., the interior surfaces of components 15,16 along seal edge 19) may be coated with an adhesive layer such that when the surfaces 15b, 16b rest on top of one another the respective, opposing edges may be adhesively connected together along substantially the entire edges of each component 15,16, (again, see seal edge 19 in FIG. 8). If desired heat may be applied to the edges to create a heat-sealed connection along substantially the entire edges of each component 15,16 at seal edge 19.

Similar to before, it should again be noted that depending on the composition of the adhesive and/or the composition of the material making up the components 15,16 an adhesive layer may be applied to each opposing (and facing) surface 15b, 16b. For example, if the adhesive coated layer is composed of a contact cement type of coating or similar, then each opposing surface 15b and 16b may be coated with an adhesive layer. In contrast, if the adhesive coated layer is composed of a super glue or similar then only one opposing surface 15b or 16b of a component may be coated with an adhesive layer. Similarly, the material composition of each component may determine the type of adhesive to be used and whether one or both opposing surfaces (e.g., at least an edge of a surface) may be coated with a layer of adhesive based on the physical or chemical interaction of the material composition with the adhesive.

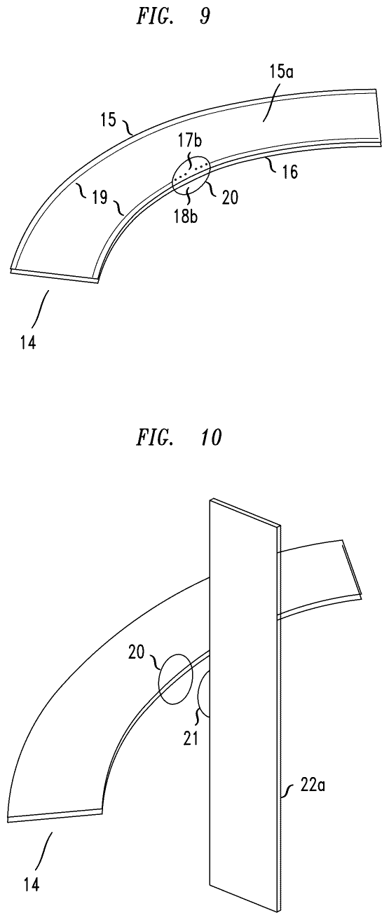

Referring now to FIG. 9 there is shown an exemplary next state of the curved inflatable component 14. As shown, interior edge flap surfaces 17b, 18b of interior surfaces 15b, 16b of inflatable components 15,16 have been folded or otherwise positioned to form a base 20 of component 14. In an embodiment, the surfaces 17b, 18b may be folded through an angle of approximately 90 degrees to form base 20.

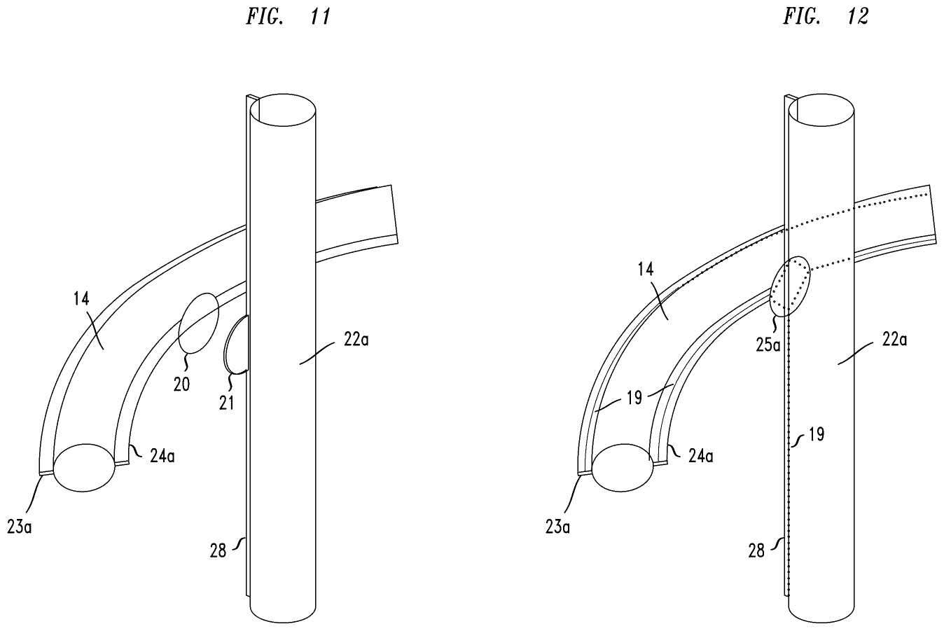

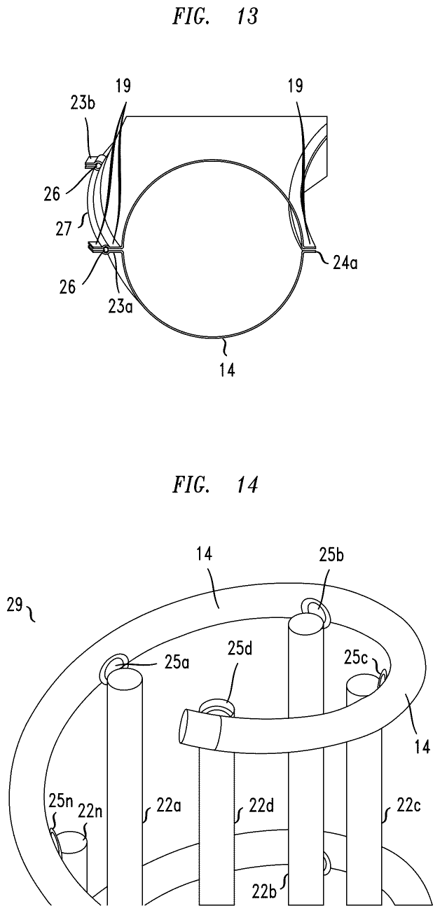

Referring now to FIGS. 10 to 12 there is depicted curved inflatable component 14 and a second, non-curved inflatable component 22a. It should be noted that inflatable component 22a may comprise a similar, straight inflatable component as component 2 or component 3 described earlier. In FIG. 10, the components 14,22a are not inflated, while in FIGS. 11 and 12 the components 14,22a are shown as inflated.

In FIGS. 10 and 11, edge flap surfaces of inflatable components 14 and 22a may be configured to form respective, opposing and connecting bases 20, 21. In one embodiment the respective bases 20, 21 may be composed of a heat sealable material having a similar composition as described previously. In an embodiment, after bases 20, 21 have been configured and positioned as shown in FIGS. 10 and 11, a joint may be formed by forcing the bases 20,21 together and applying heat (see, for example, joint 25a in FIG. 12).

In more detail, an amorphous sealant layer or similar layer on the surface of base 20 and an amorphous sealant layer or similar layer on the surface of opposing base 21 may be aligned and forced together such that when heat is applied a heat-sealed connection is created forming a joint (e.g., joint 25a in FIG. 12). In an alternative embodiment, the sealant layer on the surface of base 21 and the sealant layer on the surface of opposing base 20 may be aligned and forced together such that when heat is applied a heat-sealed connection is created forming a joint.

Similar to above, instead of (or in addition to) being composed of a heat-sealable material, bases 20, 21 may be coated with an adhesive. In such a case, the surface of one side of base 20 that faces base 21 and/or the surface of one side of base 21 that faces base 20 may be coated with an adhesive such that when the respective bases 20 and 21 are forced together the force and adhesive create a bond at joint 25a between the respective bases to connect respective components 14,22a adhesively together. If desired, heat may be applied to the bases 20, 21 to create a heat-sealed connection (i.e., joint 25a).

It should be noted that depending on the composition of the adhesive and/or the composition of the material making up the bases 20, 21, adhesive may be applied (or coated) to only one or both opposing and facing surfaces of bases 20, 21. As noted previously, if the adhesive coating is a contact cement type of coating or similar, then each opposing and facing surface of each base 20, 21 may be coated with an adhesive. In contrast, if the type of adhesive coating is a super glue or similar then only one opposing and facing surface of one base 20, 21 may be coated with an adhesive. Similarly, the material composition of each base 20, 21 may determine the type of adhesive to be used and whether one or both opposing and facing surfaces of a base may be coated based on the physical or chemical interaction of the material composition with the adhesive.

The inventors believe that the formation of a joint comprising bases 20, 21 results in a joint that has increased rotational stiffness and stability, yet the joint is still flexible enough to allow for movement of the joint without breaking the connection (i.e., the joint) as compared to joints that are not comprised of bases 20, 21 because the geometric planes containing bases 20, 21 are in shear for any rotation of the beams 14,22a relative to each other about an axis perpendicular to the center of the bases 20,21.

In embodiments of the disclosure each inflatable component 14, 22a may be connected such that, at the joint 25a, a geometric plane containing the base 20 of one component 14 is approximately orthogonal to at least one other geometric plane containing the base 21 of the other component 22a. For example, In FIG. 12, at joint 25a, the geometric plane containing component 14 and its base is approximately orthogonal to the geometric plane containing component 22a and its base as the two components 14, 22a are connected.

In yet a further embodiment the angle between the two planes containing component 14 and component 22a at the base 25a may be in the range of 85 to 95 degrees, or 87 degrees or 93 degrees, for example.

Though not shown in FIGS. 7 to 12 it should be understood that an apparatus comprising inflatable components 14, 22a may include a passageway that may be formed within joint 25a when the two bases 20, 21 are connected. In an embodiment, when the two bases are connected the passageway between components 14,22a allows a fluid (e.g., seawater), air or another inflatable medium to pass through the passageway from one component to another component. In one embodiment the diameter of the passageway formed when bases 20,21 are connected may measure 0.25-0.5 inches and may have a length of 0.125 inches to provide just one exemplary set of dimensions, it being understood that the length should be minimized to make the joint stiffer as the joint rotates.

Referring now to FIG. 13, inflatable component 14 may include wing portions 23a, 23b and 24a (inflatable component 22a may comprise rib portion 28; see FIG. 12). In one embodiment, wing portions 23a, 23b may comprise tabs, where each tab 23a,23b may be configured with an internal passageway 26 configured and dimensioned to allow at least a communications conductor 27 (e.g., one or more optical fibers) to pass therethrough. Though only two tabs 23a, 23b are shown in FIG. 13, it should be understood that this is merely exemplary. In other embodiments, a plurality of tabs greater than two may be used.

Yet further, in another alternative embodiment rather than use individual tabs 23a, 23b the wing portion 23a (as well as 24a) may be configured as one component positioned along substantially the entire length of component 14 (and portion 28 in FIG. 12 may be configured as one component positioned along substantially the entire length of component 22a). As configured, wing portion 23a may be configured with an internal passageway 26 that may be configured and dimensioned to allow at least a communications conductor 27 to pass therethrough.

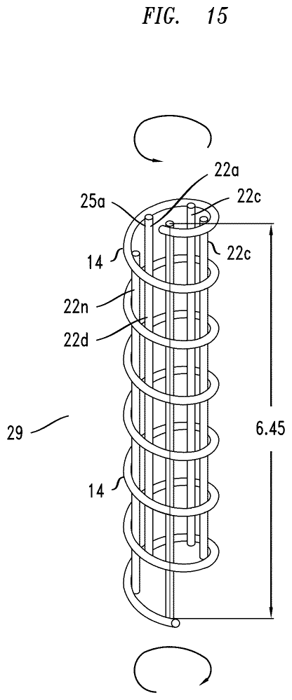

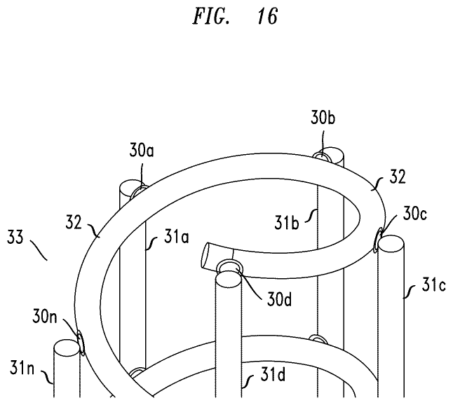

FIG. 14 depicts a portion of apparatus 29 that may be used in an underwater environment, for example. In an embodiment, the apparatus 29 may comprise one or more curved inflatable components 14 and one or more straight inflatable components 22a to 22n (where “n” indicates the last inflatable component) to form a helically shaped apparatus 29 (see FIG. 15 also), though it should be understood that a helically-shaped apparatus is only one of many shaped apparatuses that can utilize the features of the present disclosure. In alternative embodiments, apparatus 29 comprising the one or more curved inflatable components 14 and the one or more straight inflatable components 22a to 22n may form a shaped apparatus selected from a circular, conical, general, cylindrical or slanted helically-shaped apparatus, for example.

In an embodiment, each straight inflatable component 22a to 22n may be connected to one or more curved inflatable components 14 (or vice-versa) at a cross-component joint 25a to 25n to, for example, provide structural support for each of the curved inflatable components 14 and any connected communications conductor 27 and associated sensors, where each of the cross-component joints 25a to 25n are configured to allow movement of the joint without breaking the joint. As configured apparatus 29 may comprise a plurality of such cross-component joints.

Further, each of the plurality of cross-component joints 25a to 25n may comprise an internal, open passageway to allow a medium (e.g., water, air) to pass through the passageway from a respective curved inflatable component 14 to a respective straight inflatable component 22a to 22n or vice-versa,

In the embodiments shown in FIGS. 14 and 15 (and FIG. 16 described below), curved inflatable component 14 comprises one unitary, continuous component though in alternative embodiments the curved inflatable component 14 and straight inflatable components 22a to 22n may each comprise a plurality of similar, connected components (e.g., two or more similar configured and shaped components are joined into one) depending, for example, on the method and space available for additional components. Though five straight components 22a to 22n are depicted in FIGS. 14 and 15, this is merely exemplary. Fewer or more straight components 22a to 22n may be used to as a part of an exemplary apparatus depending, for example, on the dimensions of the apparatus required for a particular application.

As noted previously, each straight inflatable component 22a to 22n may be connected to each of one or more curved inflatable components 14 at a respective cross-component joint 25a to 25n. In the embodiments shown in FIGS. 14 and 15 each of the straight components 22a to 22n may be connected within the curved component at joints 25a to 25n, where the joints are located at an inner diameter of the helical apparatus. Said another way, in the embodiments depicted in FIGS. 14 and 15 the locations of the joints 25a to 25n may be at tangent contact points of a straight component 22a to 22n and the curved component 14. Accordingly, the tangent contact points may be referred to as being located on the inside surface of the helix-shaped apparatus 29.

Alternatively, one or more (e.g., all) of the joints may be located at an outer diameter of a helical apparatus when one or more (e.g., all) of the straight components are connected outside of a curved component as shown in FIG. 16. In the embodiment depicted in FIG. 16 the locations of the joints 30a to 30n may be at tangent contact points of a respective straight component 31a to 31n and a curved component 32. Accordingly, the tangent contact points may be referred to as being located on the outside surface of a helix-shaped apparatus 33.

In embodiments, the configuration of the straight inflatable components on the inside or outside of a helically-shaped component versus configuring the straight inflatable components as integral with a curved component may reduce the number of joints required in an apparatus which in turn reduces the number of possible breaks (and leakage of liquid, air) that may occur.

In an embodiment the overall height of the apparatus may be 6.45 meters or 18-19 feet though this is merely exemplary and other heights may be used depending on the application.

While benefits, other advantages, and solutions to problems have been described above with regard to specific embodiments of the present disclosure.

However, the benefits, advantages, solutions to problems, and any element(s) that may cause or result in such benefits, advantages, or solutions, or cause such benefits, advantages, or solutions to become more pronounced are not to be construed as a critical, required, or essential feature or element of any or all the claims.

The claim language that follows below is incorporated herein by reference in expanded form, that is, hierarchically from broadest to narrowest, with each possible combination indicated by the multiple dependent claim references described as a unique standalone embodiment.

We claim:

1. A method for connecting inflatable components comprising:
folding a first inflatable portion comprising a first edge flap surface of a first heat sealable component (“first component”) on top of a second inflatable portion comprising a second edge flap surface of the first component;
applying heat along substantially an entire edge formed by the folded first and second inflatable portions of the first component to form a respective heat-sealed edge connection of the first component;
folding a first inflatable portion comprising a first edge flap surface of a second heat sealable component (“second component”) on top of a second inflatable portion comprising a second edge flap surface of the second component;
applying heat along substantially an entire edge formed by the folded first and second inflatable portions of the second component to form a respective heat-sealed edge connection of the second component;
configuring the first and second edge flap surfaces of the first component as a first base;
configuring the first and second edge flap surfaces of the second component as a second base; and
connecting the first and second bases by applying a force to one or more of the bases, wherein the connection has a polar second moment of area about an axis that is perpendicular to centers of the first and second bases.

2. The method as in claim 1 wherein the first and second bases comprise an amorphous sealant layer, the method further comprising applying heat to the respective amorphous sealant layers of each respective base to form a joint.

3. The method as in claim 1 wherein a first perpendicular distance from a bottom of the first base to a respective heated-sealed edge connection of the first component is kept to a minimum and a second perpendicular distance from a bottom of the second base to a respective heated-sealed edge connection of the second component is kept to a minimum to ensure the joint maintains a sufficient degree of rotational stiffness and rigidity as the joint rotates.

4. A method for connecting inflatable components comprising:
folding a first inflatable portion comprising a first edge flap surface of a first adhesive sealable component (“first component”) on top of a second inflatable portion comprising a second edge flap surface of the first component, where the first inflatable portion comprises an external surface of the first component;
applying a force along substantially an entire edge formed by the folded first and second inflatable portions of the first component to form an adhesive-sealed edge connection of the first component;
folding a first inflatable portion comprising a first edge flap surface of a second adhesive sealable component (“second component”) on top of a second inflatable portion comprising a second edge flap surface of the second component, where the first inflatable portion comprises an external surface of the second component;
applying a force along substantially an entire edge formed by the folded first and second inflatable portions of the second component to form an adhesive-sealed edge connection of the second component;
configuring the first and second edge flap surfaces of the first component as a first base;
configuring the first and second edge flap surfaces of the second component as a second base; and
connecting the first and second bases by applying a force to one or more of the bases, wherein the connection has a polar second moment of area about an axis that is perpendicular to centers of the first and second bases.

5. The method as in claim 4 wherein one or more of the first and second bases comprise an adhesive layer.

6. The method as in claim 5, the method further comprising applying heat to the respective adhesive layer or layers to form a joint.

7. The method as in claim 4 wherein a first perpendicular distance from a bottom of the first base to a respective adhesive-sealed edge connection of the first component is kept to a minimum and a second perpendicular distance from a bottom of the second base to a respective adhesive-sealed edge connection of the second component is kept to a minimum to ensure the joint maintains a sufficient degree of rotational stiffness and rigidity as the joint rotates.

8. An apparatus for supporting a communications conductor formed by connecting inflatable components at a joint between the components, the apparatus comprising:
a first inflatable beam and a second inflatable beam connected by a cross-component joint, wherein the joint comprises an internal, open passageway to allow a medium to pass through the passageway from one of the first or second beams to the other second or first beams,
where the cross-component joint is configured to allow movement of the joint without breaking the joint.

9. The apparatus as in claim 8 wherein the medium comprises water.

10. The apparatus as in claim 8 wherein the communications conductor comprises an optical fiber.

11. The apparatus as in claim 8 wherein the first and second inflatable beams comprise a heat-sealable material.

12. The apparatus as in claim 11 wherein the heat sealable material comprises a 48, 80, or 128 gauge Mylar® 850 AB coex sealant film.

13. The apparatus as in claim 8 wherein each of the first and second inflatable beams comprise a PET crystalline layer on a first surface and an amorphous sealant layer on a second surface.

14. The apparatus as in claim 8 wherein each of the first and second beams comprise one or more surfaces coated with an adhesive.

15. The apparatus as in claim 8 wherein the joint has a polar second moment of area about an axis that is perpendicular to centers of bases of the first and second beams.

16. The apparatus as in claim 8 wherein a perpendicular distance from a bottom of a base of each respective beam to a respective seal edge of each respective beam is kept to a minimum to ensure the joint maintains a sufficient degree of rotational stiffness and rigidity as the joint rotates.

17. An apparatus formed by connecting inflatable components, the apparatus comprising:
one or more curved inflatable components and one or more straight inflatable components, wherein each of the one or more curved inflatable components is connected to at least one of the one or more straight inflatable components at a cross-component joint thereby forming a plurality of cross-component joints, wherein each of the plurality of cross-component joints comprises an internal, open passageway to allow a medium to pass through the passageway from a respective curved inflatable component to a respective straight inflatable component or vice-versa,
where each of the cross-component joints are configured to allow movement of a respective joint without breaking the respective joint.

18. The apparatus as in claim 17 wherein the one or more curved inflatable components and the one or more straight inflatable components form a helically shaped apparatus.

19. The apparatus as in claim 17 wherein the one or more curved inflatable components and the one or more straight inflatable components form a shaped apparatus selected from a circular, conical, general, cylindrical or slanted helically-shaped apparatus.

20. The apparatus as in claim 17 wherein one or more of the cross-component joints are located at an inner diameter of the apparatus.

21. The apparatus as in claim 17 wherein one or more of the cross-component joints are located at an outer diameter of the apparatus.
